(19) United States
(12) Patent Application Publication
(10) Pub. No.: US 2010/0030433 A1
(43) Pub. Date: Feb. 4, 2010

(54) Collision protection system for vehicle

(75) Inventor: Akira Suzuki, Hekinan-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/462,180

(22) Filed: Jul. 30, 2009

(30) Foreign Application Priority Data
Aug. 1, 2008 (JP) 2008-200045

(51) Int. Cl. B60R 21/0136; B60R 21/34

(52) U.S. Cl. 701/45

(57) ABSTRACT

A collision protection system for a vehicle includes an occupant protection system and a pedestrian protection system. The occupant protection system includes a first front sensor and a second front sensor for detecting a collision of the vehicle and an occupant protection device activated based on detected results of the first front sensor and the second front sensor. The pedestrian protection system includes a main sensor, a first safing sensor, and a second safing sensor for detecting a collision of the vehicle with a pedestrian and a pedestrian protection device (activated based on detected results of the main sensor, the first safing sensor, and the second safing sensor. The first front sensor and the first safing sensor are provided by a first shared acceleration sensor, and the second front sensor and the second safing sensor are provided by a second shared acceleration sensor.

### CROSS REFERENCE TO RELATED APPLICATIONS

The present application is based on and claims priority to Japanese Patent Application No. 2008-200045 filed on Aug. 1, 2008, the contents of which are incorporated in their entirety herein by reference.

### BACKGROUND OF THE INVENTION

1. Field of the Invention

The present invention relates to a collision protection system that detects a collision of a vehicle and protects an occupant and a pedestrian.

2. Description of the Related Art

An occupant protection system detects a collision of a vehicle and activates an occupant protection device including an airbag based on a detected result. The occupant protection system detects a collision mainly with an acceleration sensor (G sensor) disposed in the vehicle. When a detected result of the acceleration sensor is greater than a threshold value, the airbag is activated (i.e., inflated). The occupant protection system includes a front sensor disposed in a front part of the vehicle. The occupant protection system may include a plurality of acceleration sensors for preventing an error inflation of the airbag. For example, a main sensor for detecting a collision and a safing sensor for supporting the main sensor are disposed in the vehicle. In the above-described case, an activation/deactivation of the occupant protection device is determined based on an AND circuit of the main sensor and the safing sensor.

The pedestrian protection system detects a collision of a vehicle with a pedestrian and activates a pedestrian protection device including an active hood and a cowl airbag based on a detected result. The pedestrian protection system is disclosed, for example, in US 2007/0222236 A (corresponding to JP-A-2007-261309).

The pedestrian protection system may include a safing sensor in addition to a main sensor for preventing an error-activation of the pedestrian protection device in a manner to the occupant protection system. The main sensor includes a pressure sensor, for example. The safing sensor includes an acceleration sensor. The acceleration sensor in the pedestrian protection system detects a collision of a light object such as a pedestrian. Thus, an output range and a resolution of the acceleration sensor in the pedestrian protection system are different from an acceleration sensor in the occupant protection system. The acceleration sensor in the pedestrian protection system is disposed at a center portion of a bumper reinforcement, for example.

When the acceleration sensor in the pedestrian protection system is disposed at the center portion of the bumper reinforcement, the pedestrian protection device is difficult to detect a collision of a pedestrian depending on a collided portion. Thus, when the pedestrian protection system includes two acceleration sensors and the two acceleration sensors are disposed at a right side and a left side of a vehicle, respectively, the pedestrian protection system can detect a collision of a pedestrian with more certainty.

However, by increasing the number of acceleration sensors, a cost of the pedestrian protection system may be increased. Especially when both of the occupant protection system and the pedestrian protection system are disposed in the vehicle, each of the system requires the main sensor and the safing sensor. Thus, a cost of the sensors may be expensive.

### SUMMARY OF THE INVENTION

In view of the foregoing problems, it is an object of the present invention to provide a collision protection apparatus for a vehicle.

According to an aspect of the present invention, a collision protection system for a vehicle includes an occupant protection system and a pedestrian protection system. The occupant protection system includes a first front sensor, a second front sensor, and an occupant protection device. The first front sensor and the second front sensor are disposed in a front part of the vehicle and are configured to detect a collision of the vehicle. The occupant protection device is configured to be activated based on detected results of the first front sensor and the second front sensor. The pedestrian protection system includes a main sensor, a first safing sensor, a second safing sensor, and a pedestrian protection device. The main sensor, the first safing sensor, and the second safing sensor are disposed in the front part of the vehicle and configured to detect a collision of the vehicle with a pedestrian. The pedestrian protection device is configured to be activated based on detected results of the main sensor, the first safing sensor, and the second safing sensor. The first front sensor and the first safing sensor are provided by a first shared acceleration sensor and the second front sensor and the second safing sensor are provided by a second shared acceleration sensor.

The above-described collision protection system can improve an accuracy of the pedestrian protection system. In addition, an increase of a cost of the collision protection system can be restricted.

### BRIEF DESCRIPTION OF THE DRAWINGS

Additional objects and advantages of the present invention will be more readily apparent from the following detailed description of exemplary embodiments when taken together with the accompanying drawings. In the drawings:

FIG. 1 is a diagram illustrating a bumper of a vehicle and a collision protection system according to a first embodiment of the present invention;

FIG. 2 is a diagram illustrating a shared acceleration sensor according to the first embodiment;

FIG. 3 is a diagram illustrating a shared acceleration sensor according to a second embodiment of the present invention;

FIG. 4 is a diagram illustrating a shared acceleration sensor according to a modification of the second embodiment;

FIG. 5 is a diagram illustrating a shared acceleration sensor according to a third embodiment of the present invention; and

FIG. 6 is a diagram illustrating a shared acceleration sensor according to a modification of the third embodiment.

### DETAILED DESCRIPTION OF THE EXEMPLARY EMBODIMENTS

### First Embodiment

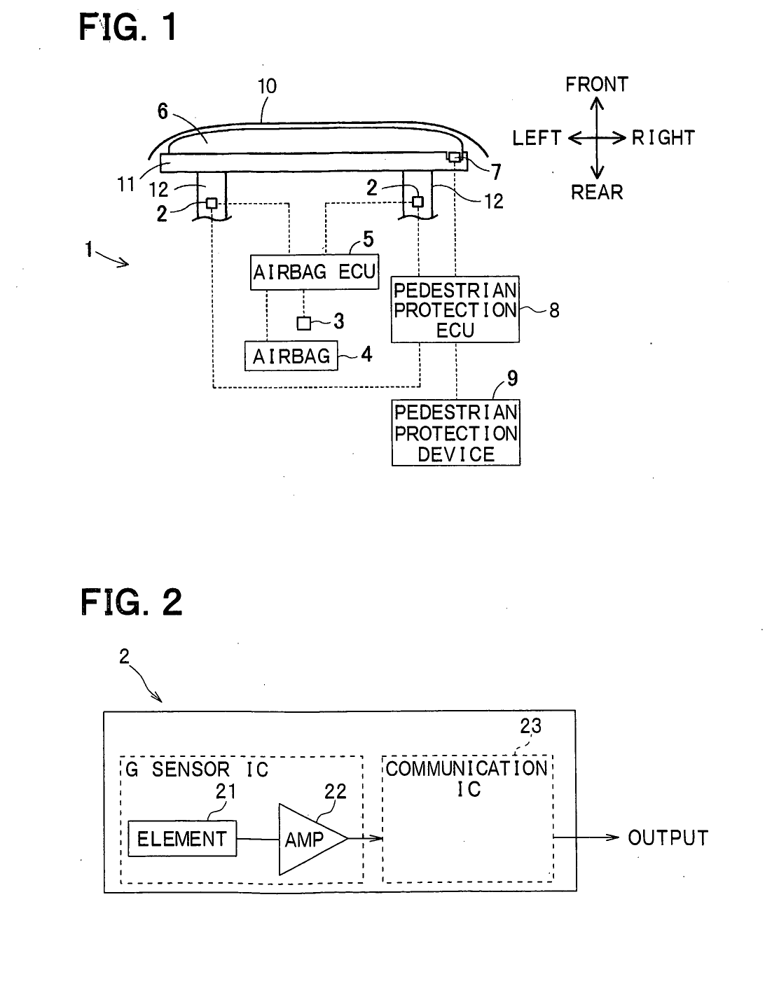

A collision protection system 1 according to a first embodiment of the present invention will be described with reference to FIG. 1 and FIG. 2.

A bumper disposed in a front part of a vehicle includes a bumper cover 10, a bumper reinforcement 11, a pair of side members 12, and a chamber member 6.

The bumper cover 10 extends in a width direction of the vehicle, that is, in a right-left direction of the vehicle. The bumper cover 10 is attached to a front end portion of a body of the vehicle so as to cover the bumper reinforcement 11 and the chamber member 6. The bumper cover 10 is made of resin, for example, polypropylene.

The bumper reinforcement 11 is disposed in the bumper cover 10 and extends in the width direction of the vehicle. The bumper reinforcement 11 is made of metal. The bumper reinforcement 11 has an approximately rectangular pipe shape having a beam at a center portion in a rectangular pipe.

The side members 12 are disposed in the vicinity of a left surface and a right surface of the vehicle, respectively, and extend in a front-rear direction of the vehicle. The side members 12 are made of metal. The bumper reinforcement 11 is attached to front end portions of the side members 12.

A collision protection system 1 includes two shared acceleration sensors 2, a center acceleration sensor 3, an airbag 4, an airbag ECU 5, the chamber member 6, a pressure sensor 7, a pedestrian protection ECU 8, and a pedestrian protection device 9. The shared acceleration sensors 2, the center acceleration sensor 3, the airbag, and the airbag ECU 5 are included in an occupant protection system. The shared acceleration sensors 2, the chamber member 6, the pressure sensor 7, the pedestrian protection ECU 8, and the pedestrian protection device are included in a pedestrian protection system.

The shared acceleration sensors 2 are disposed in the front part of the vehicle. Each of the shared acceleration sensors 2 is attached to one of the side members 12. The shared acceleration sensors 2 are coupled with the airbag ECU 5 and the pedestrian protection ECU 8. When one of the shared acceleration sensors 2 detects a collision, the one of the shared acceleration sensors 2 transmits a signal to the airbag ECU 5 and the pedestrian protection ECU 8.

The center acceleration sensor 3 is disposed at a center part of the vehicle. The center acceleration sensor 3 is coupled with the airbag ECU 5.

The airbag 4 can function as an occupant protection device. The airbag 4 is activated (i.e., inflated) when the airbag 4 receives a signal from the airbag ECU 5. The airbag ECU 5 controls an activation/deactivation of the airbag 4 based on the signals from the shared acceleration sensors 2 and the center acceleration sensor 3. When a detected result from one of the shared acceleration sensors 2 is greater than an occupant threshold value and a detected result from the center acceleration sensor 3 is greater than the occupant threshold value, the airbag 4 is activated. That is, the activation/deactivation of the airbag 4 is determined based on an AND circuit of each of the shared acceleration sensors 2 and the center acceleration sensor 3. Each of the shared acceleration sensors 2 can function as a front sensor in the occupant protection system. The occupant threshold value is set for determining whether the airbag 4 should be activated or not.

In the occupant protection system, the shared acceleration sensors 2 and the center acceleration sensor 3 respectively send the detected results to the airbag ECU 5 and the airbag ECU 5 determines the activation/deactivation of the airbag 4 based on the detected results.

The chamber member 6 is disposed in the bumper cover 10 and is attached on a front surface of the bumper reinforcement 11. The chamber member 6 has an approximately box shape extending in the width direction of the vehicle. The chamber member 6 is made of a synthetic resin. The chamber member 6 has a wall having a thickness of a few millimeters, and the wall defines an approximately-closed chamber space.

The pressure sensor 7 is attached to the chamber member 6. The pressure sensor 7 is coupled with the pedestrian protection ECU 8. The pressure sensor 7 detects a change in a pressure of the chamber space. When the chamber member 6 deforms due to a collision and the pressure of the chamber space changes, the pressure sensor 7 detects the change in the pressure. A detected result of the pressure sensor 7 is transmitted to the pedestrian protection ECU 8. The pressure sensor 7 can detect a collision of a pedestrian more directly than the shared acceleration sensors 2. Thus, the pressure sensor 7 can be used as a main sensor of the pedestrian protection system.

The pedestrian protection ECU 8 receives the detected results from the pressure sensor 7 and the shared acceleration sensors 2 and determines an activation/deactivation of the pedestrian protection device 9 based on the detected results. For example, when the detected result from the pressure sensor is greater than a pedestrian threshold value, and the detected result from one of the shared acceleration sensors 2 is greater than the pedestrian threshold value, the airbag 4 is activated. That is, the activation/deactivation of the airbag 4 is determined based on an AND circuit of each of the shared acceleration sensors 2 and the pressure sensor 7.

In the pedestrian protection system, each of the shared acceleration sensors 2 can function as a safing sensor. The pedestrian threshold value is set for determining whether the pedestrian protection device 9 should be activated or not. The pedestrian threshold value is less than the occupant threshold value. The pedestrian protection device 9 includes an active hood and a cowl airbag, for example.

As described above, the shared acceleration sensors 2 are disposed in the front part of the vehicle. Each of the shared acceleration sensors 2 can function as the front sensor of the occupant protection system and the safing sensor of the pedestrian protection system. That is, in the collision protection system 1, the front sensor of the occupant protection system and the safing sensor of the pedestrian protection system are provided by each of the shared acceleration sensors 2.

As illustrated in FIG. 2, each of the shared acceleration sensors 2 includes an element 21, an amplifier 22, and a communication IC 23. The element 21 is displaced in accordance with a change in acceleration, and generates a weak voltage in accordance with a displacement. An output range (maximum value) of the element 21 is 200 G. An output range of an acceleration sensor required for the occupant protection system is 100 G, and an output range of an acceleration sensor required for the pedestrian protection system is 50 G. Thus, each of the shared acceleration sensors 2 can be used for both of the occupant protection system and the pedestrian protection system when each of the shared acceleration sensors 2 have an output range greater than or equal to 100 G. In the present embodiment, each of the shared acceleration sensors 2 has an output range of 200 G. Thus, each of the shred acceleration sensors 2 can be used for both of the occupant protection system and the pedestrian protection system with more certainty.

The amplifier 22 is coupled with the element 21 and amplifies the weak voltage from the element 21. The element 21 and the amplifier 22 are disposed in a package and configurate a G sensor IC.

The communication IC 23 is coupled with the amplifier 22. The communication IC 23 includes an analog-digital converter (AD converter) for converting an analog signal from the amplifier 22 into a digital signal. The communication IC 23 transmits a converted digital signal to the airbag ECU 5 and the pedestrian protection ECU 8.

The AD converter in the communication IC 23 has a resolution (sensitivity) of 0.2 G/LSB (Least Significant Bit). Smaller value of resolution means higher accuracy. The pedestrian protection system is required to detect a collision of a light object including a pedestrian. For example, a sensor in the pedestrian protection system is required to discriminate between a collision and a vibration of the vehicle with certainty. A resolution required for the pedestrian protection system is 0.5 G/LSB, which is higher accuracy than a resolution required for the occupant protection system. Thus, when the resolution of the communication IC 23 is less than or equal to 0.5 G/LSB, the communication IC 23 can be used for both of the pedestrian protection system and the occupant protection system. In the present embodiment, the communication IC 23 has a resolution of 0.2 G/LSB. Thus, the communication IC 23 can be used for both of the pedestrian protection system and the occupant protection system with more certainty. Each of the shared acceleration sensors 2 may have an output range from 100 G to 200 G and may have a resolution from 0.2 G/LSB to 0.5 G/LSB.

As described above, in the collision protection system 1, the front sensor and the safing sensor can be provided by each of the shared acceleration sensors 2. Thus, the safing sensors of the pedestrian protection system are disposed at the right side and the left side in the front part of the vehicle, respectively, and thereby the pedestrian protection system can have a high accuracy. In addition, the number of acceleration sensor is not increased in the above-described configuration. Thus, an increase of a cost of the collision protection system 1 can be restricted.

In the occupant protection system, the shared acceleration sensors 2 are included in a group of sensors coupled with the airbag ECU 5. For example, the group of sensors may include only the shared acceleration sensors 2 or the group of sensors may include other acceleration sensor such as a rear sensor in addition to the shared acceleration sensors 2 and the center acceleration sensor 3.

In the pedestrian protection system, the main sensor is not limited to the pressure sensor 7. For example, an optical sensor, an optical camera, or a high-accuracy acceleration sensor may also be used as a main sensor. The shared acceleration sensors 2 may also be attached to another portion. For example, the shared acceleration sensors 2 may also be attached to respective sides of the bumper reinforcement.

### Second Embodiment

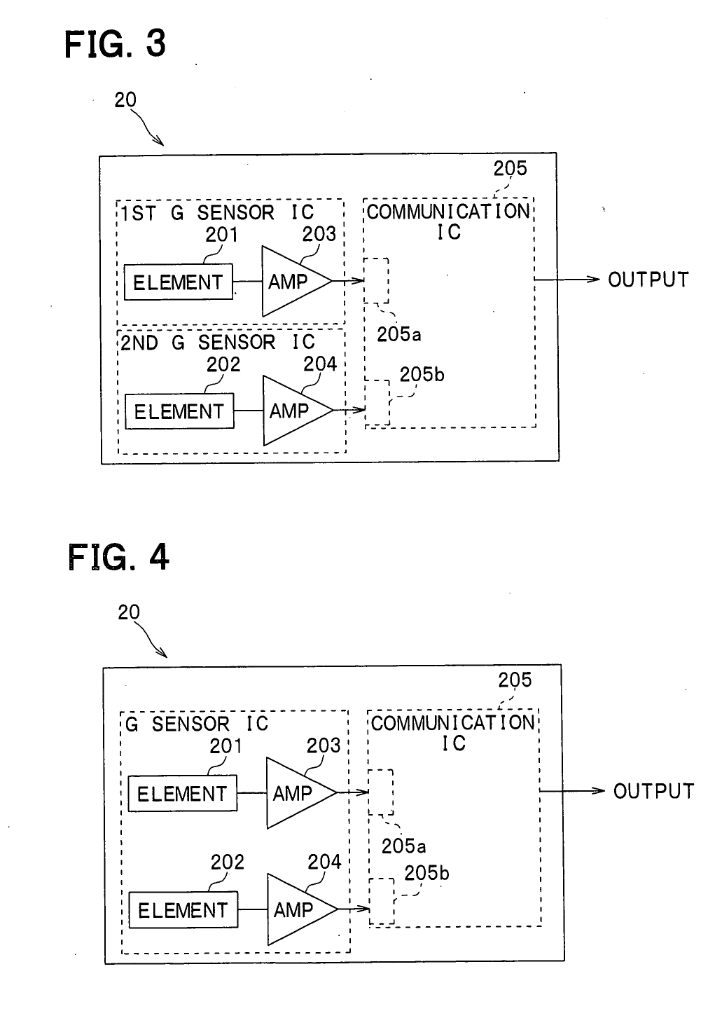

A collision protection system 1 according to a second embodiment of the present invention will be described with reference to FIG. 3 and FIG. 4. In the collision protection system 1 according to the present embodiment, shared acceleration sensors 20 are different from the shared acceleration sensors 2 described in the first embodiment. Thus, the shared acceleration sensors 20 are mainly described below.

As illustrated in FIG. 3, each of the shared acceleration sensors 20 includes a first element 201, a second element 202, a first amplifier 203, a second amplifier 204, and a communication IC 205. The first element 201 has an output range of 200 G. The second element 202 has an output ranged of 50 G. The first amplifier 203 is coupled with the first element 201 and the communication IC 205. The second amplifier 204 is coupled with the second element 202 and the communication IC 205.

The communication IC 205 converts an analog signal from the first amplifier 203 into a digital signal at a resolution of 2 G/LSB. In addition, the communication IC 205 converts an analog signal from the second amplifier 204 into a digital signal at a resolution of 0.5 G/LSB. In other words, the communication IC 205 includes a first AD converter 205a and a second AD converter 205b. The first AD converter 205a has a resolution of 2 G/LSB and is coupled with the first amplifier 203. The second AD converter 205b has a resolution of 0.5 G/LSB and is coupled with the second amplifier 204.

The communication IC 205 transmits the digital signals to the airbag ECU 5 and the pedestrian protection ECU 8. Each of the digital signals includes information so that the digital signal from the first AD converter 205a and the digital signal from the AD converter 205b can be discriminated. The signal from the first AD converter 205a is used for the occupant protection system, and the digital signal from the second AD converter 205b is used for the pedestrian protection system.

In an example illustrated in FIG. 3, the first element 201 and the first amplifier 203 are disposed in a package and configurate a first G sensor IC, and the second element 202 and the second amplifier 204 are disposed in another package and configurate a second G sensor IC. Alternatively, the first element 201, the second element 202, the first amplifier 203, and the second amplifier 204 may also be disposed in one package and may configurate a G sensor IC. In such a case, only one package is required. Thus, a cont of the collision protection system 1 can be restricted.

Even when the collision protection system 1 includes the shared acceleration sensors 20 according to the present embodiment, the collision protection system 1 can have effects similar to the first embodiment.

### Third Embodiment

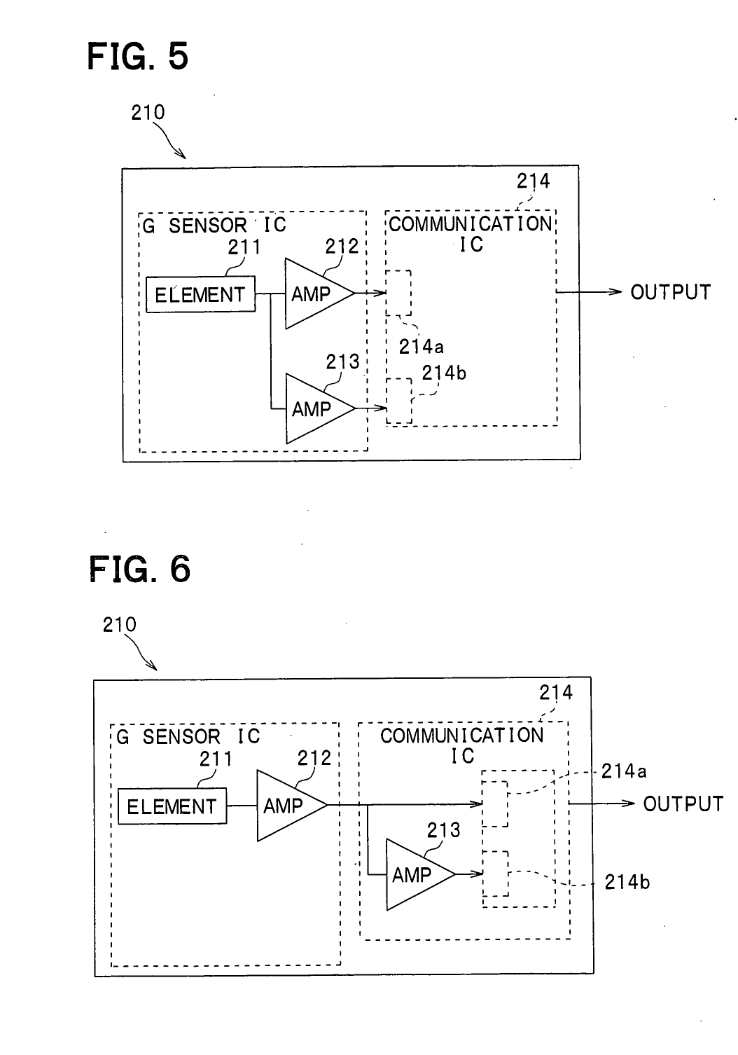

A collision protection system 1 according to a third embodiment will be described with reference to FIG. 5 and FIG. 6. In the collision protection system 1 according to the present embodiment, shared acceleration sensors 210 are different from the shared acceleration sensors 2 described in the first embodiment. Thus, the shared acceleration sensors 210 are mainly described below.

As illustrated in FIG. 5, each of the shared acceleration sensors 210 includes an element 211, a first amplifier 212, a second amplifier 213, a communication IC 214. The element 211 has an output range of 200 G. The first amplifier 212 is coupled with the element 211 and the communication IC 214. The first amplifier 212 has an amplification factor of 10 times.

The second amplifier 213 is coupled with the element 211 and the communication IC 214. The second amplifier 213 has an amplification factor of 40 times. Thus, a signal amplified by the second amplifier 213 is four times greater than a signal amplified by the first amplifier 212. By amplifying by the second amplifier 213, a small G range can be detected easily and a large G range can be saturated. That is, by providing the second amplifier 213, the shared acceleration sensor 210 can operate in a manner similar to an acceleration sensor including an element having a small output range, for example, 50 G.

The communication IC 214 converts an analog signal from the first amplifier 212 into a digital signal at a resolution of 2 G/LSB. In addition, the communication IC 214 converts an analog signal from the second amplifier 213 into a digital signal at a resolution of 0.5 G/LSB. In other words, the communication IC 214 includes a first AD converter 214a and a second AD converter 214b. The first AD converter 214a has a resolution of 2 G/LSB and is coupled with the first amplifier 212. The second AD converter 214b has a resolution of 0.5 G/LSB and is coupled with the second AD converter 214b.

The communication IC 214 transmits the digital signals to the airbag ECU 5 and the pedestrian protection ECU 8. Each of the digital signals includes information so that the digital signal from the first AD converter 214a and the digital signal from the second AD converter 214b can be discriminated. The digital signal from the first AD converter 214a is used for the occupant protection system. The digital signal from the second AD converter 214b is used for the pedestrian protection system.

Even when the collision protection system 1 includes the shared acceleration sensors 210, the collision protection system 1 can have effects similar to the first embodiment. Each of the shared acceleration sensors 210 may be modified as illustrated in FIG. 6. That is, the second amplifier 213 may be coupled with the first amplifier 212 and may be disposed in the communication IC 214. The second amplifier 213 further amplifies a signal from the first amplifier 212 by four times. Also in such a configuration, the collision protection system 1 can have effects similar to the first embodiment.

What is claimed is:

1. A collision protection system for a vehicle, comprising:
an occupant protection system including a first front sensor, a second front sensor, and an occupant protection device, the first front sensor and the second front sensor disposed in a front part of the vehicle and configured to detect a collision of the vehicle, the occupant protection device configured to be activated based on detected results of the first front sensor and the second front sensor; and
a pedestrian protection system including a main sensor, a first safing sensor, a second safing sensor, and a pedestrian protection device, the main sensor, the first safing sensor, and the second safing sensor disposed in the front part of the vehicle and configured to detect a collision of the vehicle with a pedestrian, the pedestrian protection device configured to be activated based on detected results of the main sensor, the first safing sensor, and the second safing sensor, wherein:
the first front sensor and the first safing sensor are provided by a first shared acceleration sensor; and
the second front sensor and the second safing sensor are provided by a second shared acceleration sensor.

2. The collision protection system according to claim 1, wherein
each of the first shared acceleration sensor and the second shared acceleration sensor has an output range greater than or equal to 100 G and has a resolution less than or equal to 0.5 G/LSB.

3. The collision protection system according to claim 1, wherein
each of the first shared acceleration sensor and the second shared acceleration sensor has an output range from 100 G to 200 G and has a resolution from 0.2 G/LSB to 0.5 G/LSB.

4. The collision protection system according to claim 1, wherein each of the first shared acceleration sensor and the second shared acceleration sensor including:
an element configured to be displaced in accordance with a change in an acceleration and having an output range greater than or equal to 100 G;
an amplifier coupled with the element and configured to amplify a voltage generated due to a displacement of the element; and
an analog-digital converter coupled with the amplifier, having a resolution less than or equal to 0.5 G/LSB, and configured to convert an analog signal from the amplifier into a digital signal.

5. The collision protection system according to claim 1, wherein each of the first shared acceleration sensor and the second shared acceleration sensor including:
an element configured to be displaced in accordance with a change in an acceleration and having an output range greater than or equal to 100 G;
a first amplifier coupled with the element and configured to amplify a voltage generated due to a displacement of the element with a first amplification factor;
a second amplifier coupled with the element and configured to amplify a voltage generated due to the displacement of the element with a second amplification factor greater than the first amplification factor;
a first analog-digital converter coupled with the first amplifier and configured to convert an analog signal from the first amplifier into a digital signal to be used in the occupant protection system; and
a second analog-digital converter coupled with the second amplifier, having a resolution less than or equal to 0.5 G/LSB, and configured to convert an analog signal from the second amplifier into a digital signal to be used in the pedestrian protection system.

6. The collision protection system according to claim 1, wherein each of the first shared acceleration sensor and the second shared acceleration sensor including:
an element configured to be displaced in accordance with a change in an acceleration and having an output range greater than or equal to 100 G;
a first amplifier coupled with the element and configured to amplify a voltage generated due to a displacement of the element;
a second amplifier coupled with the first amplifier and configured to further amplify the voltage amplified by the first amplifier;
a first analog-digital converter coupled with the first amplifier and configured to convert an analog signal from the first amplifier into a digital signal to be used in the occupant protection system; and
a second analog-digital converter coupled with the second amplifier, having a resolution less than or equal to 0.5 G/LSB, and configured to convert an analog signal from the second amplifier into a digital signal to be used in the pedestrian protection system.

7. The collision protection system according to claim 1, wherein
the main sensor includes one of a pressure sensor, an optical sensor, an optical camera, and an acceleration sensor.
